(19) United States
(12) Patent Application Publication
(10) Pub. No.: US 2003/0126185 A1
(43) Pub. Date: Jul. 3, 2003

(54) Data driven information processor and data processing method for processing plurality of data while accessing memory

(76) Inventors: Yasufumi Itoh, Tenri-shi (JP); Tsuyoshi Muramatsu, Nara-shi (JP); Motoki Takase, Yamatokoriyama-shi (JP)

Correspondence Address: BIRCH STEWART KOLASCH & BIRCH, PO BOX 747, FALLS CHURCH, VA, 22040-0747, US

(21) Appl. No.: 10/327,986

(22) Filed: Dec. 26, 2002

(30) Foreign Application Priority Data
Dec. 27, 2001 (JP) 2001-395874

(51) Int. Cl. G06F 9/00

(52) U.S. Cl. 709/106

(57) ABSTRACT

A data driven information processor receives a data packet including at least destination information, instruction information, and one or more data, executes a process according to a data flow program prestored in a program storage unit, and stores the processed result in the received data packet for output of the data packet. In the process, a transfer process of a plurality of data between a data memory and a data packet is performed. In this data transfer process, a plurality of addresses not continuous in the data memory are specified by addressing based on the contents of the data packet. The plurality of data read out from the specified addresses are stored in the data packet. Also, the plurality of data in the data packet are respectively written into a plurality of specified addresses not continuous.

### BACKGROUND OF THE INVENTION

1. Field of the Invention

The present invention relates to a data driven information processor and data processing method, particularly to a data driven information processor and data processing method for processing plurality of data while gaining access to the memory.

2. Description of the Background Art

In a data driven information processor, processing is performed in parallel according to the simple rule that “processing is performed when all the data required for a certain process are available and the resources such as a functional unit and the like required for that process are allocated.”

FIGS. 8A and 8B show a structure of a conventional data driven information processor and a data packet processed by such an information processor. A structure similar to that of the data driven information processor of FIG. 8A is disclosed in the documents of, for example, “Overview of Data Driven Processor with Built-in Multi-Task, Multi-Processor Function at Architecture Level” (Computer Design, March 1990), “An Evaluation of Parallel-Processing in the Dynamic Data-Driven Processor” (Microcomputer Architecture Symposium, November 1991), and the like.

The data driven information processor of FIG. 8A includes an input control unit 200 to connect an input port Pi (i=1, 2, 3, . . . , N) to input data, a junction unit 201, a paired data detection unit 202, an operation processing unit 203, a data memory 204, a program storage unit 205 prestoring a data flow program, and a branching unit 206. When the data driven information processor of FIG. 8A is envisaged to operate for image processing, image data is stored in data memory 204.

The data packet of FIG. 8B corresponds to that disclosed in Japanese Patent Laying-Open No. 9-114664. Referring to FIG. 8B, a data packet 210 includes, in correspondence, a field F1 where instruction information 211 is stored, a field F2 where destination information 212 is stored, a field F3 where a generation number 213 is stored, and a field F4 where one or more independent data 214 are stored. Instruction information 211 indicates information to identify various instructions of operations and the like applied on data 214 stored in a corresponding field F4. When instruction information 211 designates a binary operation instruction, two data 214 are stored in field F4. When a monadic operation instruction is designated, one data 214 is stored. Destination information 212 indicates information identifying which information of the data flow program in program storage unit 205 is to be fetched by data 214 in corresponding field F4. Generation number 213 indicates the information to identify a plurality of data having the same destination. Field F4 is a region where one or more data input via input control unit 200 can be stored. The maximum number of data 214 that can be stored corresponds to the number of input ports Pi. In a single data packet 210, data 214 of field F4 can share the corresponding unitary instruction information 211, destination information 212 and generation number 213. The types of information stored in data packet 210 are not limited to that described above, and other types of information (data) can further be stored.

According to the structure of FIG. 8A, input control unit 200 is an external terminal for the data driven information processor. A plurality of data independent of each other input through input port Pi are stored in field F4 of one data packet 210, and then output from data packet 210. Junction unit 201 arbitrates the input of data packet 210 output from input control unit 200 and branching unit 206 to provide data packet 210 to paired data detection unit 202 in sequence.

Paired data detection unit 202 receives an applied data packet 210 to conduct matching of data packet 210 using an internal memory not shown, if necessary, based on instruction information 211 of the input data packet 210. Specifically, when determination is made that matching is required based on instruction information 211, two different data packets 210 having a matching generation number 213 and matching destination information 212 are to be detected. The contents of field F4 in one of the two detected data packets 210 are additionally stored into field F4 of the other data packet 210, which is then output. In the case determination is made that matching is not required, for example when determination is made that instruction information 211 designates access to data memory 204, no matching is conducted, and the relevant input data packet 210 is output without operation.

Operation processing unit 203 receives data packet 210 output from paired data detection unit 202, decodes instruction information 211 stored in field F1 of input data packet 210, processes the contents of that input data packet 210 based on the decoded result, stores the processed data in input data packet 210, and outputs that data packet 210.

Program storage unit 205 prestores a data flow program including a plurality of destination information and a plurality of instruction information. When a data packet 210 is input, program storage unit 205 reads out the subsequent destination information and subsequent instruction information from the data flow program according to addressing based on destination information 212 in that input data packet 210 to store the read out destination information and instruction information into field F2 and field F1, respectively, of input data packet 210, and outputs that data packet 210.

Branching unit 206 receives data packet 210 from program storage unit 205, and determines whether input data packet 210 is to be processed again in the same data driven information processor (i.e., output to junction unit 201), or outside the data driven information processor (i.e., output to an external source). The input data packet 210 is output based on the determination result. Junction unit 201, paired data detection unit 202, operation processing unit 203, program storage unit 205 and branching unit 206 are connected by a pipeline through which data packet 210 is circulated.

When access to data memory 204 is designated according to instruction information 211 in the input data packet 210, operation processing unit 203 performs data writing or data read out into or from data memory 204 according to addressing based on generation number 213 in the input data packet 210.

In the data driven information processor disclosed in Japanese Patent Laying-Open No. 9-114664, data redundancy is reduced to improve the processing efficiency by storing a plurality of data 214 independent of each other in field F4 of one data packet 210, and sharing corresponding instruction information 211, destination information 212 and generation number 213 for the plurality of data 214.

FIG. 9 shows the manner of reading out data stored in successive addresses on data memory 204 of FIG. 8A and storing the read out data into data packet 210. In data memory 204 are stored data corresponding to each of a plurality of pixels of an image formed of a plurality of fields. Pixel data of a certain field Zk (k=1, 2, 3, . . . ) is specified by the two-dimensional address of a pixel value Xi (i=1, 2, 3, . . . ) in the X horizontal) direction and a line value Yj (j=1, 2, 3, . . . ) in the Y (vertical) direction. The address (Xi, Yj, Zk) of a certain pixel data in data memory 204 is stored as generation number 213 of data packet 210. For the sake of simplification, FIG. 9 shows the state where a field Zk in data memory 204 is addressed. Since the scanning direction of an image corresponding to two-dimensional image data corresponds to the horizontal direction (X direction) of the image, the pixel data in the horizontal direction in data memory 204 can be specified by a plurality of successive addresses. However, pixel data in the vertical direction cannot be specified by a plurality of successive addresses. The pixel data in the vertical direction can be specified by a plurality of discontinuous addresses.

When a plurality of data in data memory 204 are to be accessed using data packet 210 in the data driven information processor disclosed in Japanese Patent Laying-Open No. 9-114664, access is restricted to a plurality of data that are continuous in generation number, i.e. restricted to a plurality of data stored in regions of continuous addresses on data memory 204. Specifically, in the case where a plurality of data are read out from data memory 204 to be stored in field F4 of data packet 210, the plurality of data to be read out are restricted to data that have continuous addresses in data memory 204. Similarly, in the case where a plurality of data 214 in field F4 of data packet 210 are to be written into data memory 204, the addresses of the regions into which the plurality of data 214 are to be written had to be continuous in data memory 204.

This means that, when image data is to be processed using data memory 204, data transfer was limited only between a plurality of pixel data stored in region 301 of addresses continuous in the horizontal direction (X direction) on data memory 204 and a plurality of data 214 in field F4 of data packet 210, as shown in FIG. 9.

However, data is not always processed continuously in the order of the generation number in the operational processing carried out by the data driven information processor. For example, in the two-dimensional DCT (Discrete Cosine Transformation) process used in image compression processing, processing is required in both the horizontal direction (X direction) and vertical direction (Y direction) of the screen. However, it is impossible to arrange (store) data so that the generation number is continuous for pixels in both the horizontal and vertical directions on data memory 204.

Therefore, two-dimensional DCT processing proceeds as shown in FIGS. 10A-10E, for example, in a conventional data driven information processor. FIGS. 10A-10E correspond to the case where 8×8 pixels on data memory 204 are the subject of processing. First, a read out process 701 of reading out a plurality of pixel data (8 data in the horizontal (X) direction) from continuous addresses on data memory 204 is executed at operation processing unit 203. A data packet 210 in which pixel data read out are stored in field F4 has the next instruction information 211 (DCT instruction in the horizontal direction) stored at program storage unit 205, and then provided to operation processing unit 203. Operation processing unit 203 receives input data packet 210, applies a DCT process 702 on the contents of input data packet 210 based on instruction information 211, stores the process result in field F4 of the current data packet 210, and outputs that data packet 210. Data packet 210 is provided to program storage unit 205 where the subsequent instruction information 211 is stored. This data packet 210 is provided to operation processing unit 203.

Operation processing unit 203 receives this data packet 210, and executes a write process 703 of data 214 (intermediate result) stored in corresponding field F4 into successive addresses on data memory 204 based on instruction information 211 of the current data packet 210. Then, a process to rewrite the data in the vertical direction (Y direction) so as to be successive on data memory 204 is carried out. This process includes a process 704 of reading out and storing pixel data of the vertical direction (Y direction) into field F4 of data packet 210 and altering the corresponding generation number 213 (address). In practice, process 704 is performed for each data corresponding to one pixel.

The data (intermediate result) subjected to process 704 is written into data memory 204 (process 705). Then, a process 706 of reading out data from regions of continuous addresses from data memory 204 is performed. The read out data is stored in field F4 of data packet 210. This data packet 210 is provided to operation processing unit 203 where a DCT process 707 is applied on the data in the horizontal direction in field F4 of the input data packet 210 (at this stage, the data in the horizontal direction is converted into data in the vertical direction by the preceding process). The processed result is stored in field F4 of data packet 210. Data packet 210 with the result stored is output. Then, at operation processing unit 203, the resultant data of DCT process 706 is written into data memory 204, and a process to store the continuous data in the vertical direction (Y direction) in data memory 204 is performed. This process includes a process 708 of reading out and storing data in the vertical direction into field F4 of data packet 210, and altering the corresponding generation number 213 (address). In practice, this process 708 is performed for every data corresponding to one pixel. A process 709 of writing the processed data into data memory 204, and then a process 710 of writing the data in field F4 of data packet 210 into continuous addresses in data memory 204 are carried out. The data written into data memory 204 by write process 710 is subsequently read out as data of the two-dimensional DCT processing result for output.

Thus, transfer of a plurality of data between field F4 of data packet 210 and data memory 204 was conventionally restricted to a plurality of data located in regions of continuous addresses on data memory 204. In the case where a plurality of data in the vertical direction (Y direction) in data memory 204, i.e. a plurality of data in regions of discontinuous addresses are the subject of processing, the process of reading out and writing the plurality of data into regions of continuous addresses on data memory 204 had to be carried out. Thus, the processing efficiency was not superior.

### SUMMARY OF THE INVENTION

An object of the present invention is to provide a data driven information processor and data processing method that can execute processing of a plurality of data via a memory efficiently.

In view of the foregoing object, a data driven information processor according to an aspect of the present invention includes a data processing unit receiving a data packet including at least a destination field to store destination information, an instruction field to store instruction information, a generation field to store a generation number, and a data field to store one or more data, applying a process according to a data flow program formed of a plurality of destination information and a plurality of instruction information, and storing the processed result into the received data packet for output, and a data memory where data that is to be addressed and accessed is stored.

The process performed at the data processing unit includes a memory access process of gaining access to a data memory according to instruction information in the instruction field of the received data packet to carry out transfer data between the data field in the received data packet and a plurality of discrete addresses in the data memory for output of the data packet.

Even in the case where data of a plurality of discontinuous (discrete) addresses in the data memory are the subject of processing, processing can be executed efficiently since data can be transferred at one time between the data field of the relevant data packet and the plurality of discontinuous addresses according to the instruction information in the data packet.

The data processing unit further includes a program storage unit receiving a data packet to read out the subsequent destination information and subsequent instruction information from the data flow program according to addressing based on the contents of the destination field in the received data packet, and store the destination field and instruction field of the received data packet for output, a paired data detection unit receiving the applied data packet, and storing contents required for execution of the instruction information in the instruction field of the received data packet, and providing the data packet, an operation processing unit receiving the data packet output from the paired data detection unit to process the contents of the received data packet according to the instruction information in the instruction field of the data packet, and providing that data packet to the program storage unit, and an output control unit receiving the data packet from the program storage unit to provide the received data packet to outside the data driven information processor or to the paired data detection unit according to the destination information in the destination field of the received data packet. The operation processing unit can include a memory access unit executing a memory access process.

Therefore, in the case where a memory access process is executed in the operation processing unit when data of a plurality of discontinuous (discrete) addresses in the data memory are the subject of processing, the memory access process can be executed efficiently since data transfer can be conducted at one time between the data field of the relevant data packet and the plurality of discontinuous addresses according to the instruction information in the data packet.

In the data transfer operation, data can be read out from a plurality of addresses in the data memory and stored in the data field of the received data packet. Accordingly, data stored in a plurality of discontinuous addresses in the data memory can be read out and stored into one data packet by executing only one instruction information.

In the data transfer operation, plurality of data in the data field of the received data packet can be written into a plurality of discontinuous addresses, respectively, in the data memory. Accordingly, the plurality of data stored in the data packet can be written into the plurality of discontinuous addresses in the data memory, respectively, for storage by executing only one instruction information.

The memory access unit may include an address generation unit generating a plurality of addresses based on the generation number in the generation field of the received data packet according to instruction information in the instruction field of the received data packet.

Therefore, a plurality of discontinuous addresses specified in the data memory can be generated based on the generation number of the data packet during a memory access process.

The above address generation unit may have a displacement value sequentially added to the address indicated by the generation number to generate a plurality of addresses. Since a plurality of discontinuous addresses specified in the data memory can be generated by such an adding operation during the memory access process, a plurality of addresses can be readily generated.

The above displacement value may be constant for each adding operation. Therefore, access can be gained for every addresses of a constant interval in the data memory.

The above displacement value may be variable for each adding operation. Accordingly, access can be gained for every address of an irregular interval in the data memory.

In the case where a plurality of pixel data of a two-dimensional image in the vertical direction and horizontal direction on the memory are to be stored, the above displacement value may be the value used to generate an address corresponding to the plurality of pixel data in the vertical direction.

As to the two-dimensional image data, pixel data in the direction corresponding to the scanning direction of the screen, i.e. in the horizontal direction of the image in the data memory, is specified by continuous addresses whereas pixel data in the vertical direction of the image are specified by discontinuous (discrete) plurality of addresses. Therefore, by using the displacement value as the value to generate an address corresponding to a plurality of pixel data in the vertical direction of the image in the data memory, a plurality of pixel data in the vertical direction can be accessed by executing only one instruction information.

To achieve the above object, a data processing method according to another aspect of the present invention includes the steps of receiving a data packet storing at least destination information, instruction information, a generation number and one or more data, applying a data process according to a data flow program prepared in advance based on the contents of the received data packet, and storing the processed result in said received data packet for output. The data process includes a data transfer process between a plurality of discrete addresses specified based on the contents of the received data packet in a data memory prepared in advance and the received data packet.

In the case where data of a plurality of discrete addresses in the data memory, i.e., data of a plurality of discontinuous addresses, are the subject of data processing, data processing can be executed efficiently since data can be transferred at one time between the data packet and the plurality of addresses.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows a structure of a data driven information processor according to an embodiment of the present invention together with data input/output between a data packet and a data memory.

FIG. 2 is a block diagram of a structure of the operation processing unit of FIG. 1.

FIG. 3 shows a structure of the read unit of FIG. 2 together with peripheral circuitry.

FIG. 4 shows a structure of the write unit of FIG. 2 together with peripheral circuitry.

FIG. 5 shows the relationship between the image field data stored in data memory 204 and data in a data packet.

FIGS. 6A-6C show the flow of a DCT process according to an embodiment.

FIG. 7 shows an example of a data flow program stored in a program storage unit.

FIGS. 8A and 8B show a structure of a conventional data driven information processor and a data packet processed by such an information processor.

FIG. 9 shows the manner of reading out data stored in continuous addresses in the data memory of FIG. 8A and storing the read out data into a data packet.

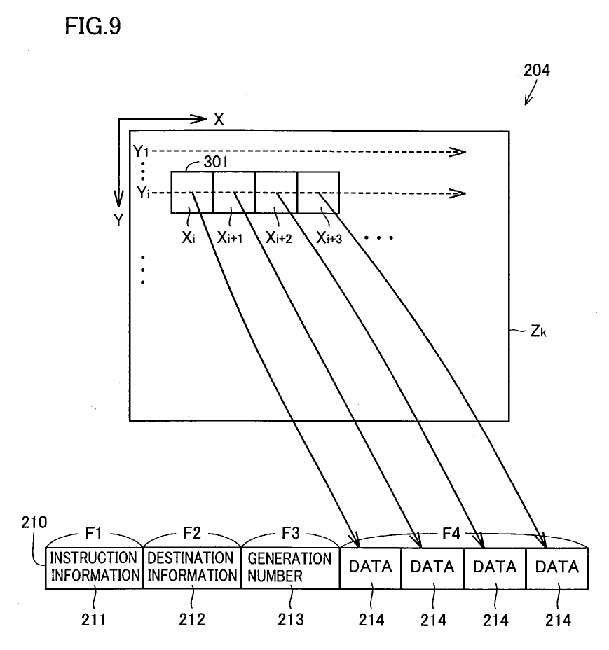

FIGS. 10A-10E show the flow of a process by means of a data memory in a conventional DCT process.

### DESCRIPTION OF THE PREFERRED EMBODIMENTS

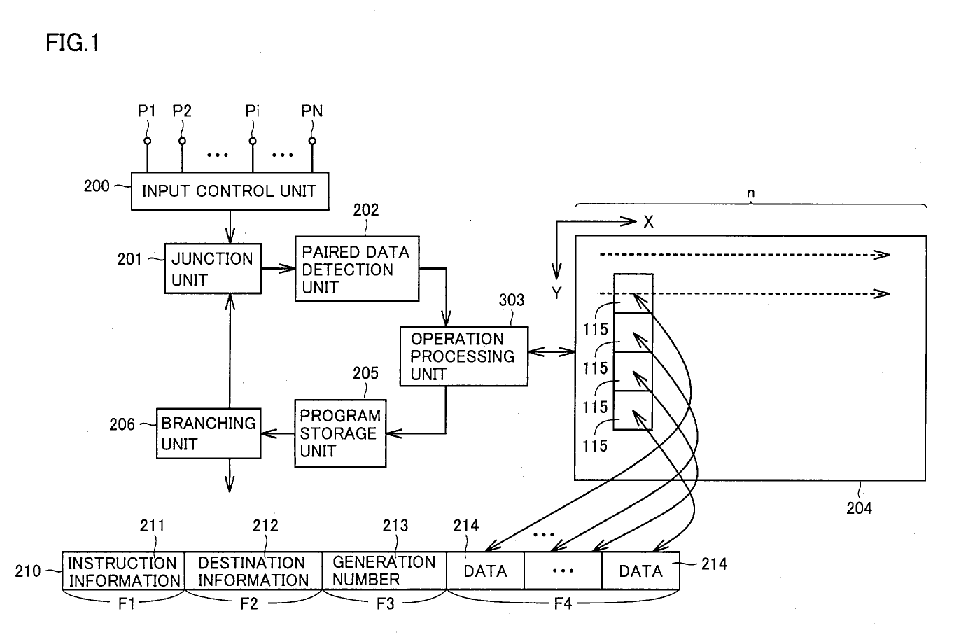

FIG. 1 shows a structure of a data driven information processor according to an embodiment of the present invention together with the manner of data input/output between a data packet and a data memory. In the present embodiment, transfer is allowed between a plurality of data 214 in field F4 of a data packet 210 and a plurality of data 115 stored in every “n” addresses in a data memory 204.

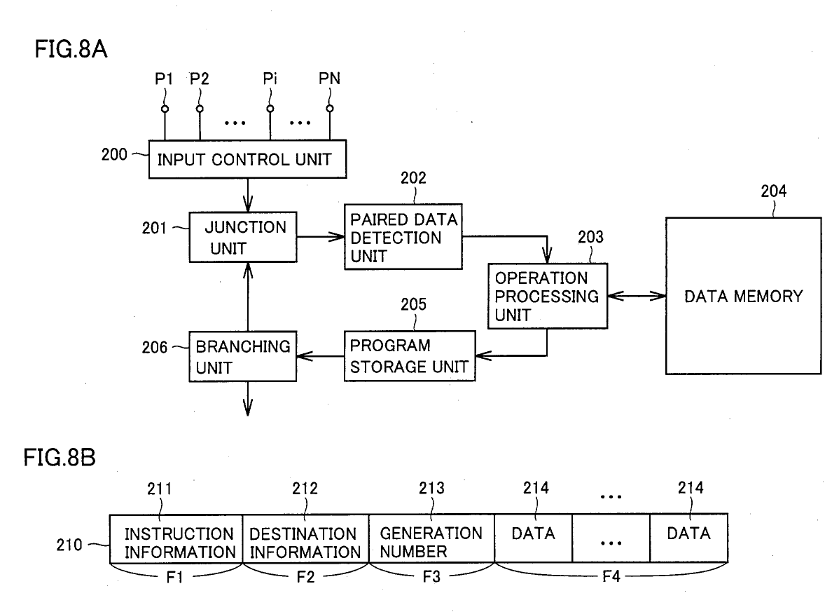

The data driven information processor of FIG. 1 differs from the data driven information processor of FIG. 8A in that an operation processing unit 303 is provided in the data driven information processor of FIG. 1 instead of operation processing unit 203 of FIG. 8A. The remaining structure is similar to that of FIG. 8A. Therefore, description thereof will not be repeated. The data driven information processor of the present embodiment executes a process using a data packet 210 of FIG. 8B.

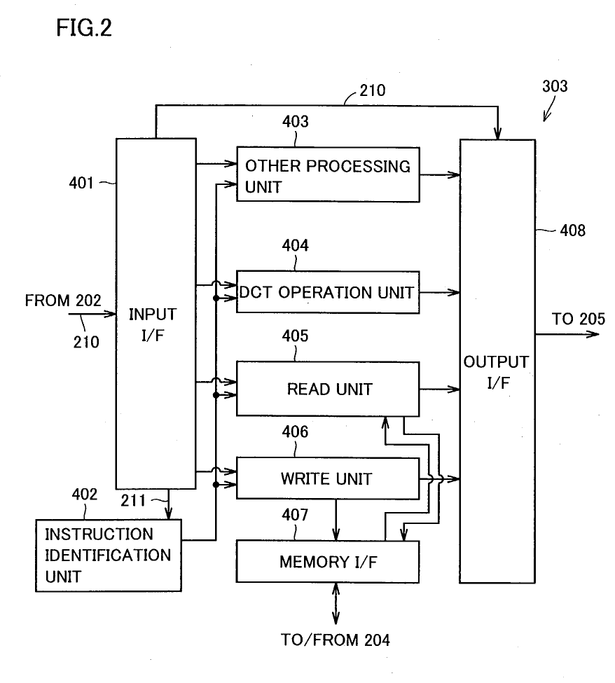

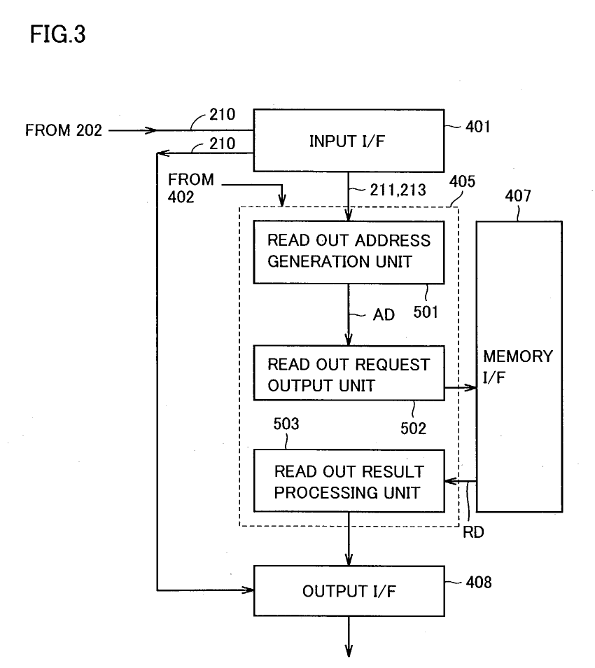

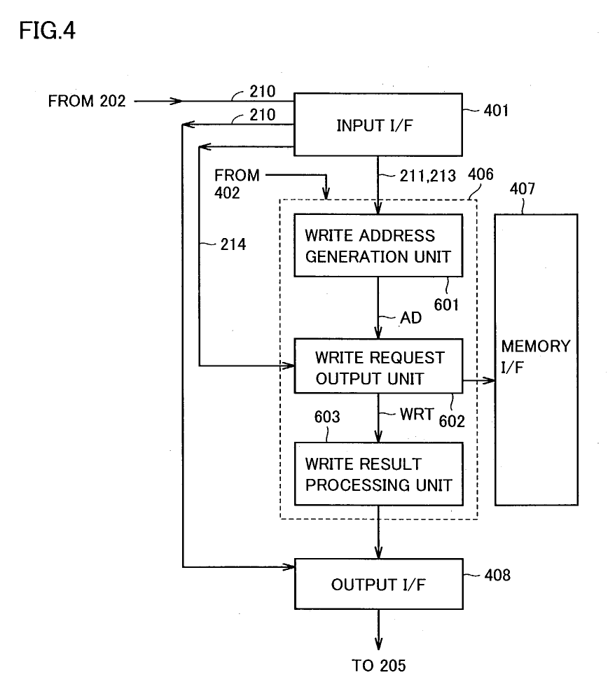

Referring to FIG. 2, operation processing unit 303 of FIG. 1 includes an input I/F (abbreviation of interface) 401, an instruction identification unit 402, an other processing unit 403, a DCT operation unit 404, a read unit 405 (refer to FIG. 3), a write unit 406 (refer to FIG. 4), a memory I/F 407, and an output I/F 408. Input I/F 401 inputs a data packet 210 output from paired data detection unit 202 to provide the input data packet 210 to other processing unit 403, DCT operation unit 404, read unit 405, write unit 406, and output I/F 408. Input I/F 401 provides instruction information 211 in the input data packet 210 to instruction identification unit 402. Operation processing unit 303 receives a data packet 210 to execute a data process according to a data flow program (instruction information 211) prepared in advance based on the contents of received input data packet 210, and stores the processed result in received data packet 210 for output. According to the data processing method, each component operates as set forth below.

Instruction identification unit 402 decodes the applied instruction information 211 to render active any of other processing unit 403, DCT operation unit 404, read unit 405 and write unit 406 based on the decoded result. When determination is made that instruction information 211 indicates a DCT operation as a result of decoding by instruction identification unit 402, DCT operation unit 404 is rendered active. When determination is made of data read out from data memory 204, read unit 405 is rendered active. When determination is made of a write instruction of the contents of corresponding data field F4 into data memory 204, write unit 406 is rendered active. When determination is made that instruction information 211 indicates other various instructions such as addition or subtraction, other processing unit 403 is rendered active. Output I/F 408 receives and temporarily stores data packet 210 from input I/F 401. When data is written into the temporarily stored data packet 210 by any of other processing unit 403, DCT operation unit 404 and read unit 405, or when a write result is applied by write unit 406, that data packet 210 is output to program storage unit 205.

In the case where other processing unit 403 is rendered active, a process according to the aforementioned various instructions is executed based on the contents of the input data packet 210. The executed result is written into data packet 210 stored in output I/F 408.

In the case where DCT operation unit 404 is rendered active, a DCT operation process is executed based on the contents of the input data packet 210. The operation result is written into data packet 210 stored in output I/F 408.

In the case where read unit 405 is rendered active, data is read out from the address in data memory 204 indicated by corresponding generation number 213 based on instruction information 211 in the input data packet 210. The data read out is written into field F4 of data packet 210 stored in output I/F 408.

In the case where write unit 406 is rendered active, the contents in corresponding field F4 is written into an address in data memory 204 indicated by corresponding generation number 213 based on instruction information 211 in the input data packet 210. The written result is applied to output I/F 408. Each of read unit 405 and write unit 406 gains access to data memory 204 via memory I/F 407. Thus, data is transferred between an address in data memory 204 and field F4 in data packet 210 by read and write units 405 and 406.

Referring to FIG. 3, read unit 405 includes a read out address generation unit 501, a read out request output unit 502, and a read out result processing unit 503. Read unit 405 performs data processing according to instruction information 211 (data flow program) in the input data packet 210 using respective elements included therein. The processed result (data read out) is stored into data packet 210 for output.

When read unit 405 is rendered active by instruction identification unit 402, read out address generation unit 501 generates address data AD indicating the address to access data memory 204 based on instruction information 211 and generation number 213 in data packet 210 input from input I/F 401. The generated address data AD is provided to read out request output unit 502.

Read out request output unit 502 operates to receive applied address data AD, and read out data from data memory 204 via memory I/F 407 according to the addressing based on the received address data AD. As a result of this operation, data RD read out from data memory 204 is applied to read out result processing unit 503 via memory I/F 407. Read out result processing unit 503 receives data RD to store the same in field F4 of data packet 210 in output I/F 408.

Read unit 405 functions to process a read out instruction of reading out a plurality of data from data memory 204 to generate a data packet 210 in which are stored the plurality of data RD read out in field F4. Instruction information 211 corresponding to such a function can be assigned one of a plurality of types of instruction codes such as “MREAD” and “MREADn”.

Instruction code “MREAD” designates read out of a plurality of data stored in successive addresses on data memory 204 when a process using such plurality of data is to be executed. Instruction code “MREADn” designates read out of a plurality of data stored at every other n addresses on data memory 204 when a process using such plurality of data is to be executed.

In a DCT process in the vertical direction in the above-described two-dimensional DCT process employed in image processing, instruction information 211 is assigned an instruction code “MREADn”. When instruction code “MREADn” is assigned, read out address generation unit 501 converts generation number 213 into the address in data memory 204 based on generation number 213 (generation number 213 may directly match address “Ai”, or be converted by a certain value in advance) and instruction code “MREADn” in the input data packet 210. Specifically, a discrete address obtained by sequentially adding displacement value “n” to address “Ai”, i.e. addresses Ai, Ai+n, Ai+2n, . . . that are not continuous are sequentially generated and provided to read out request output unit 502 as address data AD.

Read out request output unit 502 sequentially reads out a plurality of data from data memory 204 based on sequentially applied address data AD (addresses Ai, Ai+n, Ai+2n, . . . ). The plurality of data RD read out are applied to read out result processing unit 503. Read out request processing unit 503 stores as data 214 each of a plurality of data RD applied (read out) to field F4 of data packet 210 temporarily stored at output I/F 408. Then, that data packet 210 is output from output I/F 408.

The number of data RD read out from data memory 204 by instruction code “MREADn” or “MREAD” may be fixed, or determined based on the contents of field F1 where the relevant instruction code is stored. In the latter case, read out address generation unit 405 determines the number of addresses to be generated based on the number of data designated at field F1 since the number of data RD to be read out is designated by the contents of field F1. Thus, data RD corresponding in number to the number designated at field F1 can be read out from data memory 204.

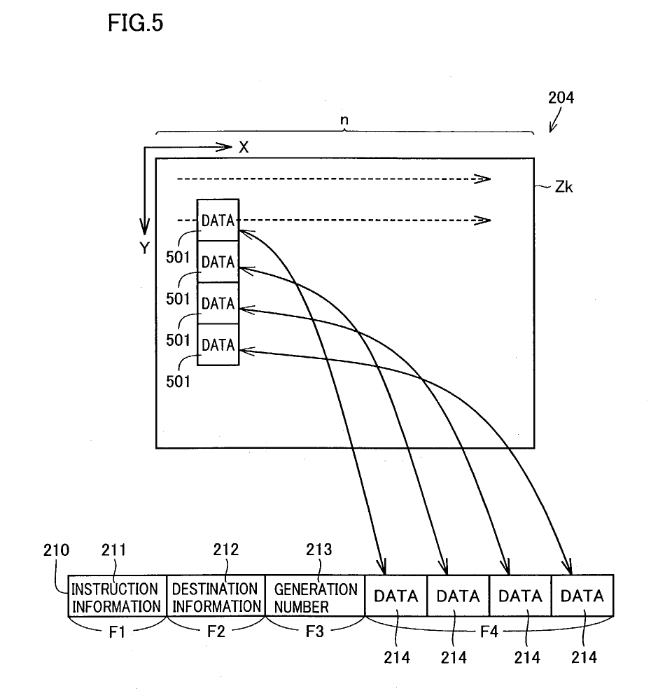

The data stored in address Ai and the data stored in address Ai+n in data memory 204 correspond to two pixel data 501 adjacent in the vertical (Y) direction in the same field in data memory 204, as shown in FIG. 5, when the displacement value “n” indicates the address length corresponding to the number of data stored in the horizontal direction of the image field.

In the case where instruction information 211 is assigned an instruction code “MREAD”, addresses Ai, Ai+n, Ai+2n, . . . are sequentially generated according to the above-described procedure, and data stored in such generated addresses are read out from data memory 204 to be stored as data 214 in field F4 of data packet 210.

In the case where a data process is executed of storing a plurality of data in data memory 204 into one data packet 210, the data to be processed was conventionally limited to those on data memory 204 that are located successively. In the present embodiment, this data process is executed by the procedure set forth below using instruction code “MREADn”. A plurality of data whose corresponding respective addresses are not continuous are read out from data memory 204 and stored as data 214 in field F4 of data packet 210. Therefore, a process that uses a plurality of data not continuous in the corresponding addresses on data memory 204, for example a DCT process, can be executed without the conventionally required process of having to read out data in the vertical direction (Y direction) and write the same into the horizontal direction (X direction).

FIG. 4 shows a structure of write unit 406 of FIG. 2 together with peripheral circuitry. Referring to FIG. 4, write unit 406 includes a write address generation unit 601, a write request output unit 602, and a write result processing unit 603. Data 214 in field F4 of data packet 210 input to input I/F 401 is applied to write request output unit 602 by means of input I/F 401. Write unit 406 carries out data processing according to instruction information 211 (data flow program) in the input data packet 210 using the aforementioned elements to output data packet 210.

When write unit 406 is rendered active by instruction identification unit 402, write address generation unit 601 generates address data AD to indicate the address that is to be accessed in data memory 204 based on instruction information 211 and generation number 213 of data packet 210 input from input I/F 401. The generated address data is output to write request output unit 602.

Write request output unit 602 operates so as to receive applied address data AD to write the contents of field F4 of the input data packet 210 into data memory 204 via memory I/F 407 according to the addressing based on the input address data AD. The contents to be written correspond to data 214 applied from I/F 401 with respect to write request unit 602. The write result WRT is applied to write result processing unit 603. Write result processing unit 603 receives a write result WRT to output designation with respect to output I/F 408 based on write result WRT. Write unit 406 has the capability to process a write instruction to write a plurality of data 214 into data memory 204. Instruction information 211 corresponding to such a feature can be assigned any of a plurality of types of instruction codes including an instruction code “MWRITE” and an instruction code “MWRITEn”. Instruction code “MWRITE” designates writing of a plurality of corresponding data 214 into continuous addresses on data memory 204. Instruction code “MWRITEn” designates writing of a plurality of corresponding data 214 into every other “n” addresses indicated by displacement value “n” on data memory 204.

When instruction code “MWRITEn” is assigned to instruction information 211 in data packet 210 and write unit 406 is rendered active by instruction identification unit 402, write address generation unit 601 sequentially generates discrete addresses ‘Ai’, ‘Ai+n’, ‘Ai+2n’, . . . based on generation number 213 in the input data packet 210 (generation number 213 may directly match address “Ai”, or be converted by a certain value in advance) and an instruction code assigned to instruction information 211. Each sequentially generated address is provided to write request output unit 602 as address data AD.

Write request output unit 602 writes each of a plurality of data 214 stored in field F4 of the input data packet 210 (may be data 214 subjected to an operation by operation processing unit 303) into discontinuous addresses (addresses ‘Ai’, ‘Ai+n’, ‘Ai+2n’, . . . ) indicated by each applied address data AD. When write result processing unit 603 detects that a plurality of data 214 stored in field F4 of data packet 210 have been written into data memory 204 according to write result WRT, write result processing unit 603 designates output I/F 408 to output data packet 210. When the relevant data packet 210 is output from output I/F 408 to program storage unit 205, the process of operation processing unit 303 on data packet 210 ends. Write result processing unit 603 may write result WRT into field F4 of data packet 210 in output I/F 408, and output data packet 210 in which write result WRT is written.

The data written in address Ai and the data written in address Ai+n in data memory 204 correspond to two pixel data 501 adjacent in the vertical (Y) direction in the same field in data memory 204, as shown in FIG. 5, when displacement value “n” indicate the address length corresponding to the number of data stored in the horizontal (X) direction in the image field.

When instruction code “MWRITE” is assigned to instruction information 211, data AD indicating address ‘Ai’, ‘Ai+n’, ‘Ai+2n’, . . . is sequentially generated in accordance with the above-described procedure. Each of the plurality of corresponding data 214 is written into respective addresses indicated by generated address data AD in data memory 204.

According to a data processing method of the data driven information processor of FIG. 1, a plurality of independent data stored in discontinuous addresses in data memory 204 can be read out and stored in one data packet 210. The plurality of data 214 stored in field F4 of data packet 210 can be respectively written into a plurality of discontinuous addresses in data memory 204. Accordingly, in the process of image data, data transfer can be conducted between a plurality of pixel data stored in discontinuous addresses (in this case, continuous pixel data in the vertical direction (Y)) and the contents of field F4 (plurality of data 214) in one data packet 210.

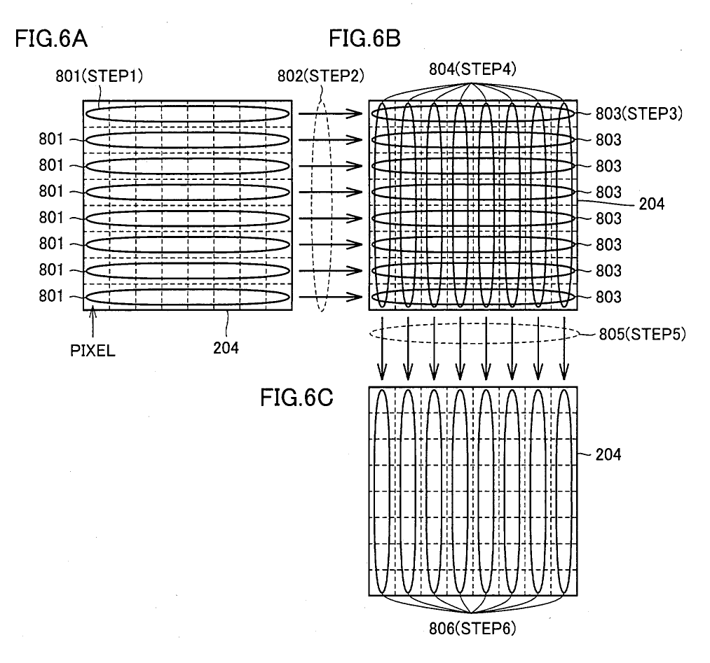

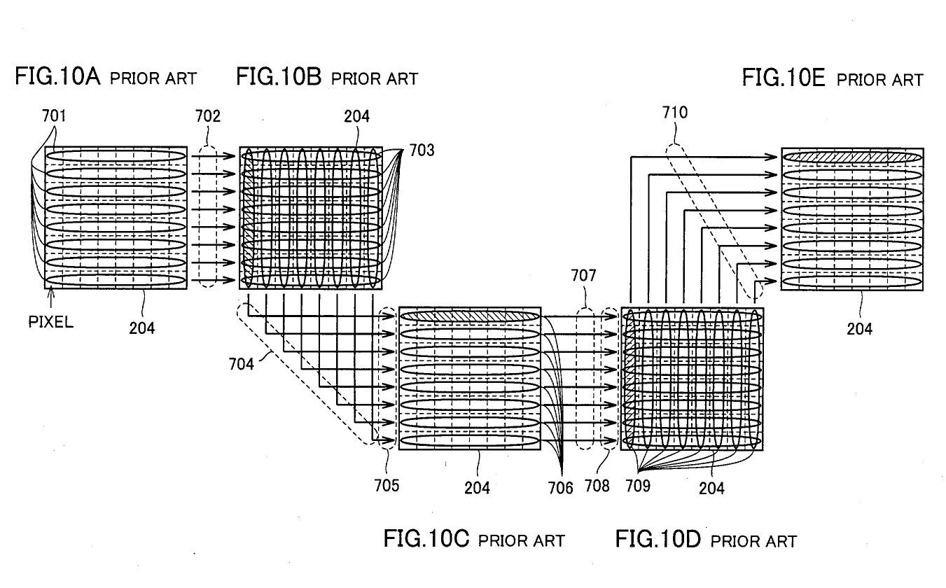

According to the present embodiment, a two-dimensional DCT process via memory 204 can be executed as shown in FIGS. 6A-6C by steps 1-6 set forth below. In memory 204 of FIG. 6B, the intermediate resultant data of a two-dimensional DCT process is stored. For example, a read out process 801 of a plurality of pixel data (a plurality of data stored in continuous addresses on data memory 204 of FIG. 6A) in the horizontal direction (X direction) is executed (step 1). Then, the plurality of data read out are stored in data packet 210, and a DCT process 802 in the horizontal direction is executed at operation processing unit 303 (step 2). A process 803 of writing into continuous addresses on data memory 204 of FIG. 6B a plurality of data 214 (intermediate result) subjected to the DCT operation process in field F4 of data packet 210 is executed (step 3). A process 804 of reading out a plurality of data in the vertical direction in data memory 204 is executed (step 4). Then, a DCT process 805 in the vertical direction is applied on the plurality of data read out from field F4 of data packet 210 by operation processing unit 203 (step 5). A process 806 of writing a plurality of data 214 subjected to the DCT operation process in field F4 of data packet 210 into regions of addresses adjacent in the vertical direction in data memory 204 is executed. Output data corresponding to the two-dimensional DCT processing result is written into data memory 204 of FIG. 6C (step 6). Thus, processing is improved in efficiency as compared to the conventional processing shown in FIGS. 10A-10E.

In the present embodiment, the number of data 214 written into data memory 204 by instruction code “MWRITEn” or “MWRITE” may be constant or variable based on the contents in field Fl where the instruction code was stored. In the case of the latter, the number of data 214 written is designated by the contents of field F1. Therefore, write address generation unit 601 determines the number of addresses to be generated based on the number designated in field F1. Accordingly, data 214 of a corresponding number designated at field F1 can be written into data memory 204.

An example of a plurality of data 214 in field F4 in data packet 210 of FIG. 1 includes data having continuous corresponding addresses in data memory 204 and sharing the same instruction information 211 and destination information 212. In this case, generation number 213 can be directed to the generation number for one data 214 in date field F4. The generation number corresponding to other data 214 in data field F4 can be recovered from the storage position (address) of the relevant data in data memory 204.

Now, consider the case where a process of a plurality of data 214 with discontinuous generation numbers 213 is to be carried out. The process to be carried out in the case where data is written into data memory 204 by, for example, instruction code “MWRITEn” and reading out the written data by an instruction code “MREADn”, or reading out data from data memory 204 by instruction code “MREADn” and writing the data read out into data memory 204 by instruction code “MWRITEn” is set forth below. With the original generation number 213 in data packet 210 still saved, instruction information 211 and destination information 212 in data packet 210 are set at program storage unit 206 so as to indicate an instruction and destination that handles the plurality of corresponding data 214 as having generation numbers not continuous. Accordingly, appropriate processing can be conducted.

In the case where a process in which a generation number 213 differing from generation number 213 when data packet 210 was generated is to be handled, a plurality of data stored in continuous addresses on the data memory 204 are read out, and a data packet 210 is generated in which the plurality of data read out (data 214) are stored in field F4, for example. In the case where a process is to be carried out of writing each of a plurality of data 214 into addresses for every other displacement value of “n” in data memory 204, a process set forth below is to be carried out. After data packet 210 is produced, an instruction and designation to carry out writing while handling the corresponding plurality of data 214 with discontinuous generation numbers are set into instruction information 211 and destination information 212 of data packet 210 at program storage unit 205. Accordingly, appropriate processing can be conducted.

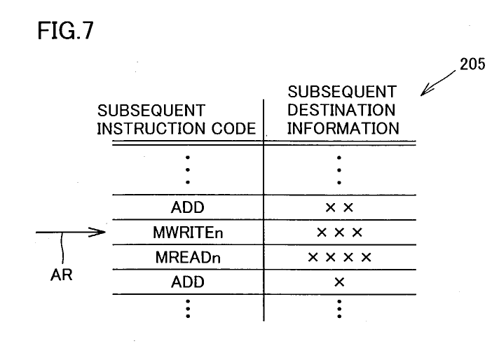

Specifically, assume that, for example, a data flow program as shown in FIG. 7 is stored in program storage unit 205. Following production of data packet 210, the subsequent instruction code “MWRITEn” and the corresponding subsequent destination information indicated by an arrow AR are read out from the data flow program in FIG. 7 according to the addressing based on destination information 212 of the relevant data packet 210. The read out instruction code and destination information are stored as instruction information 211 and destination information 212 in fields F1 and F2 in data packet 210. Accordingly, appropriate processing can be conducted.

In the case where reading (writing) is to be conducted for a plurality of data according to instruction code “MREADn” (instruction “MWRITEn”) as described above, the reading (writing) operation may be carried out a plurality of times individually for each data, or carried out concurrently or simultaneously for the plurality of data.

Although an address generation feature is individually provided for read unit 405 and write unit 406 (read out address generation unit 501, write address generation unit 601) in the present embodiment, read unit 405 and write unit 406 may share one address generation feature.

Although the displacement value “n” of instruction code “MREADn” (instruction code “MWRITEn”) is a fixed value in the present embodiment, the value may be set variable for every adding operation of address generation. Specifically, read out address generation unit 501 and write address generation unit 601 may alter displacement value “n” every time an address is calculated and generated. This alteration may be based on a predetermined rule preset at read out address generation unit 501 and write address generation unit 601, or based on a rule designated in accordance with the contents of the input data packet 210.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A data driven information processor comprising:
a data processing unit receiving a data packet including at least a designation field to store destination information, an instruction field to store instruction information, a generation field to store a generation number, and a data field storing one or more data, applying a process according to a data flow program formed of a plurality of destination information and a plurality of instruction information, and storing a processed result into said received data packet for output, and
a data memory storing data to be addressed and accessed,
wherein said process in said data processing unit includes a memory access process of accessing said data memory according to said instruction information in said instruction field in said received data packet to perform data transfer between said data field in said received data packet and a plurality of addresses that are discrete in said data memory for output of said data packet.

2. The data driven information processor according to claim 1, wherein, in said data transfer, a plurality of data of said plurality of addresses are read out from said data memory, and stored in said data field in said received data packet.

3. The data driven information processor according to claim 1, wherein, in said data transfer, said plurality of data in said data field in said received data packet are written into said plurality of addresses, respectively, in said data memory.

4. The data driven information processor according to claim 1, wherein said data processing unit further includes
program storage means for receiving said data packet to read out subsequent destination information and subsequent instruction information from said data flow program stored in advance according to addressing based on contents of said destination field in said received data packet, and storing said read out subsequent destination information and instruction information into said destination field and said instruction field, respectively, in said received data packet for output of said data packet,
paired data detection means for receiving an applied data packet to store contents required for execution of said instruction information in said instruction field in said received data packet for output of said data packet,
operation processing means for receiving said data packet output from said paired data detection means for processing contents of said received data packet according to said instruction information in said instruction field in said received data packet, and providing said data packet to said program storage means, and
output control means receiving said data packet output from said program storage means for providing said received data packet outside said data driven information processor or to said paired data detection means according to said destination information in said destination field in said received data packet,
wherein said operation processing means includes memory access means for executing said memory access process.

5. The data driven information processor according to claim 4, wherein said memory access means comprises address generation means for generating said plurality of addresses based on said generation number in said generation field in said received data packet according to said instruction information in said instruction field in said received data packet.

6. The data driven information processor according to claim 5, wherein said address generation means sequentially adds a displacement value to an address indicated by said generation number for generating said plurality of addresses.

7. The data driven information processor according to claim 6, wherein said displacement value is constant for every said adding.

8. The data driven information processor according to claim 6, wherein said displacement value is variable for every said adding.

9. The data driven information processor according to claim 6, wherein, when a plurality of pixel data of a two-dimensional image in a vertical direction and a horizontal direction in said data memory are to be stored, said displacement value is a value used to generate an address corresponding to said plurality of pixel data in said vertical direction.

10. A data processing method comprising the steps of receiving a data packet storing at least destination information, instruction information, a generation number, and one or more data, applying a data process according to a data flow program prepared in advance based on contents of said received data packet, and storing a processed result in said received data packet for output,
wherein said data process includes a process of data transfer between a plurality of discrete addresses that are specified based on contents of said received data packet and said received data packet.

11. The data processing method according to claim 10, wherein, in said data transfer, a plurality of data of said plurality of addresses are read out from said data memory, and said plurality of data read out are stored in said received data packet.

12. The data processing method according to claim 10, wherein, in said data transfer, said plurality of data in said received data packet are respectively written into said plurality of addresses in said data memory.

13. The data processing method according to claim 10, wherein said plurality of addresses for data transfer are generated based on said generation number of said received data packet according to said instruction information in said received data packet.

14. The data processing method according to claim 13, wherein said plurality of addresses are generated by sequentially adding a displacement value to an address indicated by said generation number.

15. The data processing method according to claim 14, wherein said displacement value is constant for every said adding.

16. The data processing method according to claim 14, wherein said displacement value is variable for every said adding.

17. The data processing method according to claim 14, wherein, when a plurality of pixel data of a two-dimensional image in a vertical direction and a horizontal direction in said data memory are stored, said displacement value is a value used to generate an address corresponding to said plurality of pixel data in said vertical direction.
